(19) United States
(12) Patent Application Publication
(10) Pub. No.: US 2006/0219738 A1
(43) Pub. Date: Oct. 5, 2006

(54) Foamer dispenser

(76) Inventors: Shigeo IIzuka, Tokyo (JP); Hiroshi Mizushima, Tokyo (JP)

Correspondence Address: OLIFF & BERRIDGE, PLC, P.O. BOX 19928, ALEXANDRIA, VA, 22320, US

(21) Appl. No.: 10/564,943

(22) PCT Filed: Feb. 17, 2005
(86) PCT No.: PCT/JP05/02486

§ 371 Date: May 9, 2006

(30) Foreign Application Priority Data
Feb. 20, 2004 (JP) 2004-044623
Jan. 26, 2005 (JP) 2005-018173

(51) Int. Cl. B67D 5/58

(52) U.S. Cl. 222/190

(57) ABSTRACT

A foamer dispenser includes a dual pump (30) for separately sucking, pressurizing and pressure-feeding the contents within a container and ambient air; a head (40) configured to define a merging space (R) for merging outlet passages (P3, P4) of the pump (30) with each other, the head (40) having a passage (42) for communicating the merging space (R) with an ejecting end (41) communicated with the outside; and a foaming element (50) disposed within the passage (42) of the head (40). The foaming element (50) includes a jet ring (51) having an inlet opening (H) with an opening area narrower than that of the passage (42) of the head (40), the jet ring (51) having a tubular body (51b) with an opening area larger than that of the opening (H) and communicated with the passage (42), and a mesh (52a) disposed to face to the opening (H), the mesh having a number of fine holes to be contacted with the contents supplied from the opening (H) to allow a part of the contents to pass through the mesh. The mesh (52a) has an opening diameter (φ2) which is 2.0 to 3.5 times, preferably 2.2 to 3.2 times, as large as an opening diameter (φ1) at the inlet opening of the jet ring.

### TECHNICAL FIELD

The present invention relates to a foamer dispenser for ejecting a foamy mixture of air and liquid contents.

### BACKGROUND ART

Containers filled with liquid contents, such as facial wash, hair dressing, etc., are widely used as being combined with a foamer dispenser capable of creating a foam from the contents within the container and directly ejecting the same, from a standpoint of eliminating a foaming operation for the liquid contents and thereby attaining expedient usage. Such a dispenser is configured, for example, as a dual pump comprising: a cylinder attached to a base cap fixedly held at a container mouth; a liquid piston accommodated within the cylinder and configured to suck, pressurize, and pressure-feed the liquid contents; and an air piston accommodated within the cylinder and coaxially arranged in series with the liquid piston, and configured to suck, pressurize, and pressure-feed the ambient air. In this case, the pistons are reciprocated within the cylinder by repeating depressing and returning operations of a depression head which slidably holds the outer periphery of the upper end of the air piston, to thereby separately suck, pressurize, and pressure-feed the contents and ambient air, which are mixed with each other within a merging space and then passed through a foaming element so that a foamy mixture passed through an internal passage of the depression head is ejected from an ejecting end of the depression head.

For the above usage purpose, there has been practically provided a foaming element including: a jet ring having a narrow inlet opening with an opening area narrower than that of the internal passage of the depression head to thereby increase the ejecting speed of the contents to be mixed, the jet ring comprising a tubular body with an opening area larger than that of the inlet opening; and a mesh disposed within the tubular body of the jet ring so as to face to the inlet opening, and configured to contact with the contents mixed with the ambient air and supplied from the inlet opening, thereby allowing a part of the contents to pass through the mesh; to enable creation of a foam having a fineness suitable for the usage (refer to JP-A-8-230961, for example).

However, the present inventors have found that even such a foamer dispenser noted above causes fluctuation in the foam quality depending upon the contents to be foamed such that the ejected coarse foam mixedly includes small and large air bubbles, and have confirmed that a further improvement is possible for creation of foam that is fine and homogeneous to exhibit an excellent appearance and provide comfortable hand feeling.

### DISCLOSURE OF THE INVENTION

It is therefore an object of the present invention to provide a foamer dispenser capable of eliminating fluctuation in foam quality which may be otherwise caused depending upon the contents, thereby assuredly allowing creation of fine and homogeneous foam irrespectively of the contents.

The present invention provides a foamer dispenser comprising: a base cap fixedly held at a container mouth; two pumps attached to the base cap and configured to separately suck, pressurize, and pressure-feed ambient air and the liquid contents filled in the container; a depression head for defining a merging space for merging outlet passages of the pumps with each other, the depression head having an ejecting end communicated with the outside, and the depression head having an internal passage for communicating the merging space with the ejecting end, so as to eject contents mixed with the ambient air from the ejecting end by repeating depressing and returning operations of the depression head; and a foaming element disposed within the internal passage of the depression head and configured to foam the contents mixed with the ambient air; wherein the foaming element comprises: a jet ring having an inlet opening with an opening area narrower than that of the internal passage of the depression head, the jet ring comprising a tubular body with an opening area larger than that of the inlet opening and communicated with the internal passage of the depression head; and a mesh disposed within the tubular body of the jet ring so as to face to the inlet opening of the jet ring, the mesh having a number of fine holes to be contacted with the contents mixed with the ambient air and supplied from the inlet opening to allow a part of the contents to pass through the mesh; and wherein the mesh has an opening diameter φ2 which is 2.0 to 3.5 times, preferably 2.2 to 3.2 times, as large as an opening diameter φ1 at the inlet opening of the jet ring.

With the foamer dispenser according to the present invention, since the mesh has the opening diameter φ2 which is 2.0 to 3.5 times, preferably 2.2 to 3.2 times, as large as the opening diameter φ1 at the inlet opening of the jet ring, it is possible to eject a foam having a fine and homogeneous foam quality irrespectively of the contents, thereby exhibiting an excellent appearance and providing comfortable hand feeling of the foam when received on user's hand.

In the present invention, it is preferred that the jet ring has a tapered surface having a constant gradient or a curved surface having a continuously varying gradient, connecting between the inlet opening and the mesh. In this case, it becomes possible to reduce an affection of turbulent flow on the foam quality within the jet ring.

Further, it is preferred in the present invention that the pumps are constituted as a dual pump comprising: a cylinder suspended from a lower surface of the base cap, and configured to cooperate with an inner periphery of the mouth of the container to define an annular gap therebetween which is communicated with an interior of the mouth and sealed by the base cap; and two pistons arranged in series with each other within the cylinder so as to be slidable therein; and that the pistons are configured to separately suck, pressurize, and pressure-feed the contents within the container and the ambient air.

Preferably, the dual pump is formed with an ambient air introduction port at a cylinder portion constituting the pump for sucking, pressurizing, and pressure-feeding the ambient air, the ambient air introduction port being blocked by the piston for sucking, pressurizing, and pressure-feeding the ambient air when the piston is in a stationary state where the piston is kept from sliding, and the ambient air introduction port being released from the piston when the piston is depressed, to thereby introduce ambient air into the container. By the provision of such an ambient air introduction port, there is eliminated the necessity of an ambient air sucking valve conventionally used to compensate for a negative pressure to be caused within the container by the pumping action, thereby allowing a reduced cost by virtue of the reduced number of parts.

### BRIEF DESCRIPTION OF THE DRAWINGS

The present invention will be described hereinafter in more detail based on the preferred embodiments shown in the accompanying drawing.

FIG. 1 is a cross-sectional essential-part view of a foamer dispenser according to an embodiment of the present invention.

FIG. 2 is an enlarged essential-part view of FIG. 1.

FIG. 3 is an enlarged cross-sectional view of a foaming element of this embodiment.

FIGS. 4(a) through 4(c) are a top view, an enlarged cross-sectional view, and a bottom view of a foaming element according to another embodiment of the present invention, respectively.

FIG. 5 is a cross-sectional essential-part view of the foaming element of FIG. 4 in a state where a mesh ring at a depression head side is excluded to show only a mesh ring fixed at an inlet opening side.

FIG. 6 is another cross-sectional essential-part view of the foaming element of FIG. 4 in a state where a mesh ring at the inlet opening side is excluded to show only a mesh ring fixed at the depression head side.

FIG. 7 is still another cross-sectional essential-part view of the foaming element of FIG. 4 in a state where a mesh of a mesh ring is arranged to face toward the depression head.

FIG. 8 is yet another cross-sectional essential-part view of the foaming element of FIG. 4 to illustrate a combining manner for fitting grooves of the mesh ring onto one group of ribs provided at the jet ring.

FIG. 9 is a still further cross-sectional essential-part view of the foaming element of FIG. 4, to illustrate another combining manner for fitting grooves of the mesh ring onto the other group of ribs provided at the jet ring.

FIG. 10(a) and FIG. 10(b) are schematic views illustrating a quality of foam created by a conventional dispenser and a quality of foam created by the dispenser of the present invention, respectively.

### BEST MODE FOR CARRYING OUT THE INVENTION

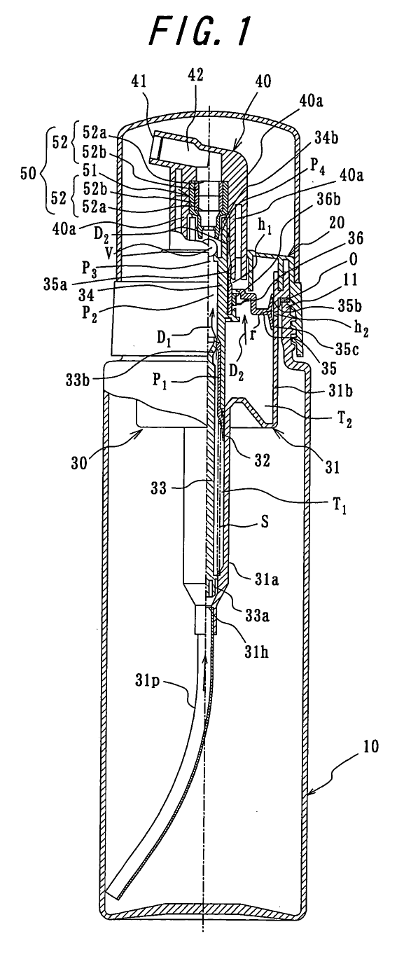

As shown in FIG. 1, reference numeral 10 designates a bottle type container for containing therein liquid contents, which has a mouth 11 carrying a base cap 20 threadedly, detachably and fixedly held thereon, and the base cap 20 has a dual pump 30 attached thereto and configured to separately suck, pressurize, and pressure-feed the contents within the container 10 and ambient air.

The pump 30 has a cylinder 31, which is undercut fitted to the base cap 20 and suspended from a lower surface of the base cap 20, and which comprises: a small diameter tubular portion 31a having an introduction port 31h communicated with a pipe 31p for sucking up the contents within the container 10; and a large diameter tubular portion 31b integrally continuing to the small diameter tubular portion 31a in series therewith.

The small diameter tubular portion 31a has disposed therein: a piston 32 elastically supported by a spring S interposed between the piston and the small diameter tubular portion 31a, and adapted to slide within the small diameter tubular portion 31a; a poppet valve 33 relatively detachably fitted in a passage P1 defined by the piston 32 therein; and a piston guide 34 defining a passage P2 therein to be opened and closed as an upper end 33b of the poppet valve 33 is contacted with and separated from the piston 32 through the passage P1, the piston guide 34 being configured to depress the piston 32 and the poppet valve 33. Further, the piston guide 34 includes an upper end 34b having an inner periphery defining an outlet passage P3 of the contents pump, and the outlet passage P3 is opened and closed by a ball valve V and communicated with the passage P2. These components cooperate with each other to suck, pressurize, and pressure-feed the contents.

Arranged in the large diameter tubular portion 31b are: an air piston 35 slidably mounted around an outer periphery of the piston guide 34, within the large diameter tubular portion 31b; and an air piston valve 36 configured to allow ambient air to be introduced from an ambient air introduction port h1 penetrating through the air piston 35 into a space between the air piston 35 and the large diameter tubular portion 31b, the air piston valve 36 being further configured to prevent a reverse flow of the ambient air; to thereby suck, pressurize, and pressure-feed the ambient air.

Reference numeral 40 designates a depression head with a nozzle. The depression head 40 has a cylindrical portion 40a which slidably holds an outer periphery of an upper end 35b of the air piston 35 and which is fitted with the outer periphery of the upper end 34b of the piston guide 34, in a manner that the piston guide 34 and air piston 35 can be depressed. Further, the depression head 40 defines a merging space R therein for merging the outlet passage P3 of the contents pump with an outlet passage P4 of the ambient air pump through a foaming element 50 to be described later, and has an internal passage 42 for communicating the merging space R with an ejecting end 41 communicated with the outside.

The foaming element 50 comprises a jet ring 51 internally fitted in the cylindrical portion 40a of the depression head 40, and two mesh rings 52 fitted in the jet ring 51. The jet ring 51 has a narrow inlet opening H with an opening area narrower than that of the internal passage 42 of the depression head 40 to thereby increase an ejecting speed of the contents to be mixed, the jet ring 51 comprises a tubular body 51b with an opening area SO larger than that of the inlet opening H and communicated with the internal passage 42, and the jet ring 51 cooperates with an inner periphery of the upper end 34b of the piston guide 34 to define the merging space R. The mesh rings 52 each comprise a mesh 52a having a plurality of small holes and attached to one end of a hollow tubular body 52b, and the applicable mesh 52a is disposed within the tubular body 51b of the jet ring 51 to face toward the inlet opening H so as to be contacted with the contents from the inlet opening H in a state mixed with ambient air, and so as to allow a part of the contents to pass through the plurality of small holes, thereby foaming the contents mixed with the ambient air.

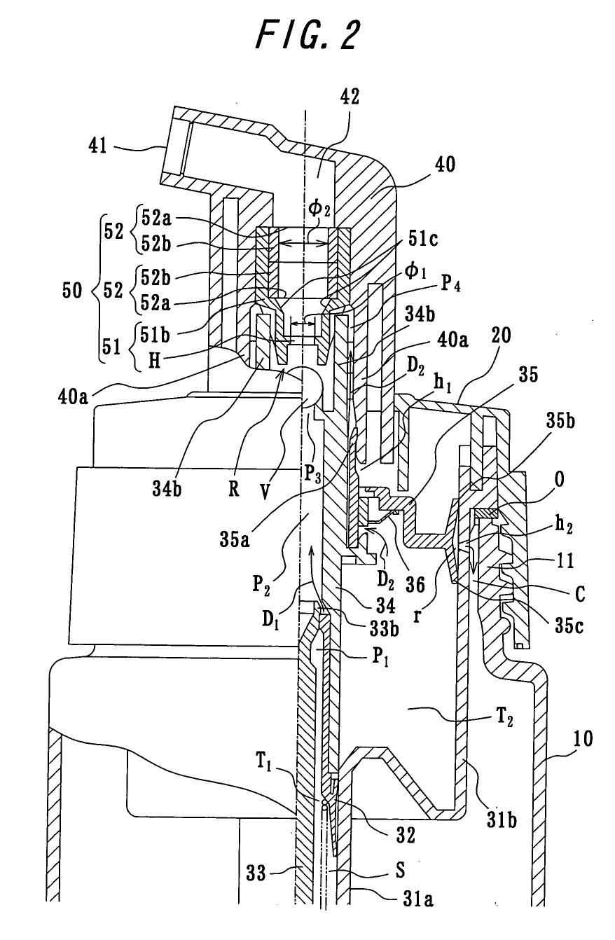

Thus, as the depression head 40 is depressed by a finger, for example, the lower end 33a of the poppet valve 33 seats onto the introduction port 31h within the small diameter tubular portion 31a to thereby define a cylinder chamber T1 between the piston 32 and the poppet valve 33, and the contents within the cylinder chamber T1 are pressurized by the depression of the piston 32 to cause the upper end 33b of the poppet valve 33 to be separated from the passage P1 of the piston 32, thereby allowing the contents to be pressure-fed into the outlet passage P3 as represented by arrow D1 in FIGS. 1 and 2. This opens the ball valve V so that the contents are supplied into the merging space R. Simultaneously with the above, the air piston 35 in the large diameter tubular portion 31b pressurizes the ambient air within a cylinder chamber T2 defined between the air piston 35 and the large diameter tubular portion 31b such that the pressure within the cylinder chamber T2 exceeds a predetermined pressure, upon which the air piston 35 slides on the piston guide 34 and is separated from the piston guide 34, so that the ambient air is pressure-fed to the outlet passage P4 as represented by arrow D2 in FIGS. 1 and 2. Thus, also the ambient air is supplied to the merging space R, so that the contents mixed with the ambient air are foamed by being passed through the inlet opening H of the jet ring 51 and through the meshes 52a of the mesh rings 52, and thereafter ejected to the outside from the ejecting end 41 of the depression head 40.

In turn, as the finger is released from the depression head 40, the piston 32 is lifted within the small diameter tubular portion 31a by a returning action of the spring S such that the upper end 33b of the poppet valve 33 is fitted in the passage P1 of the piston 32, so that also the poppet valve 33 is lifted and thus separated from the introduction port 31h to thereby suck the contents through the pipe 31p into the cylinder chamber T1. Simultaneously, in the large diameter tubular portion 31b, the air piston 35 is lifted together with the piston guide 34 and relatively slides on the piston guide 34 to block the outlet passage P4 by the returning action of the spring S, thereby causing a negative pressure within the cylinder chamber T2, which opens the air piston valve 36 to suck ambient air through the ambient air introduction port h1.

In this way, the foamer dispenser ejects the contents mixed with ambient air in a foamed state from the ejecting end 41, by repeating the depressing and returning operations of the depression head 40.

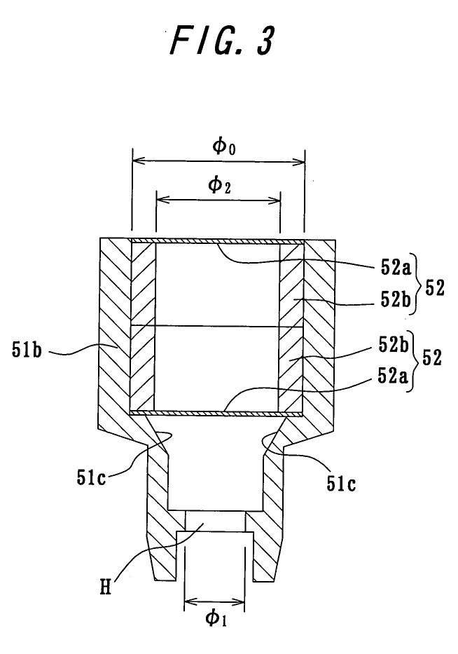

Here, the foamer dispenser according to this embodiment is set to meet the following relationship as shown in FIG. 3, in terms of a ratio between an opening diameter φ1 of the inlet opening H and an opening diameter φ2 of each mesh 52a across a region with which the contents mixed with the gas from the inlet opening H are contacted:
φ1:φ2=1:2.0 to 3.5
Namely, the meshes 52a in this embodiment each have a contact area S2 which is 4.0 to 12.3 times as large as an opening area S1 of the inlet opening H. As a concrete example, the inlet opening H has the opening diameter φ1 of 2 mm, thus the opening area S1 is 3.14 mm², and each mesh 52a has the opening diameter φ2 of 5.6 mm across a region with which the contents mixed with the gas from the inlet opening H are contacted, thus the contact area S2 is 24.6 mm².

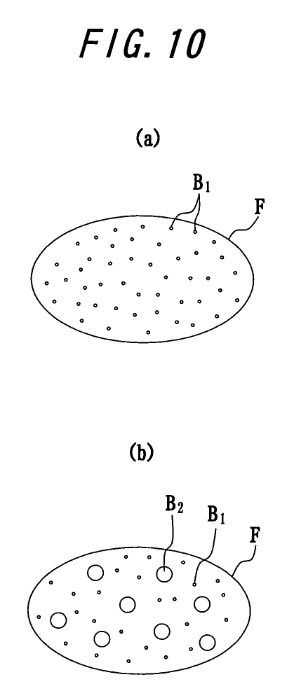

According to such a constitution, there is ejected a foam F having a fine and homogeneous foam quality where the foam is exclusively formed of small air bubbles B1 as shown in FIG. 10(a) irrespectively of the contents, thereby allowing exhibition of excellent appearance and comfortable hand feeling of the foam when presented on a hand of user. In contrast to the above, in a foamer dispenser where the above conditions are not met by a ratio between an opening diameter φ1 of an inlet opening H and an opening diameter φ2 of each mesh 52a, there is ejected a foam F mixedly including small air bubbles B1 and large air bubbles B2 depending on the contents, thereby possibly failing to assuredly create a foam having excellent appearance and comfortable hand feeling.

Additionally, the jet ring 51 according to this embodiment is configured to have a tapered surface 51c having a constant gradient and connecting between the inlet opening H and the applicable mesh 52a as shown in FIG. 3. Such a configuration enables promotion of creation of a fine and homogeneous foam. Note that it is also possible to adopt such a configuration to connect between the inlet opening H and the applicable mesh 52a of the jet ring 51, through a curved surface having a continuously changed gradient, instead of the tapered surface 51c.

Further, in this embodiment, the air piston 35 has seal surfaces 35a, 35b as shown in FIG. 2, which are provided by upwardly and downwardly bifurcating that periphery of the air piston which slides along the large diameter tubular portion 31b, thereby defining a sealed annular space “r” between an inner surface of the large diameter tubular portion 31b and the seal surfaces 35a, 35b and around the piston guide 34. Further, the large diameter tubular portion 31b cooperate with an inner periphery of the mouth 11 of the container 10 to define an annular gap C therebetween which is communicated with an interior of the mouth 11 and sealed by a sealing member (such as packing) O and the base cap 20, and this large diameter tubular portion (cylinder portion) 31b is formed with an ambient air introduction port h2, which is blocked by the sealed space “r” in a stationary state where the air piston 35 is not slid within the large diameter tubular portion 31b, and which is released when the air piston 35 is depressed to thereby introduce ambient air into the container 10. In this case, there is eliminated the necessity of an ambient air sucking valve conventionally used to compensate for a negative pressure to be caused within the container 10 by the pumping action, thereby allowing a reduced cost by virtue of the reduced number of parts.

In this embodiment, the inlet opening H and meshes 52a of the jet ring 51 may be each polygonal such as triangular, rectangular, or circular in cross-sectional shape. In case of non-circular cross-sectional shapes as represented by polygons such as triangle and rectangle, the above-described opening diameter ratio refers to a ratio of diameters of corresponding circles having the same cross-sectional areas as the non-circular cross-sections, respectively.

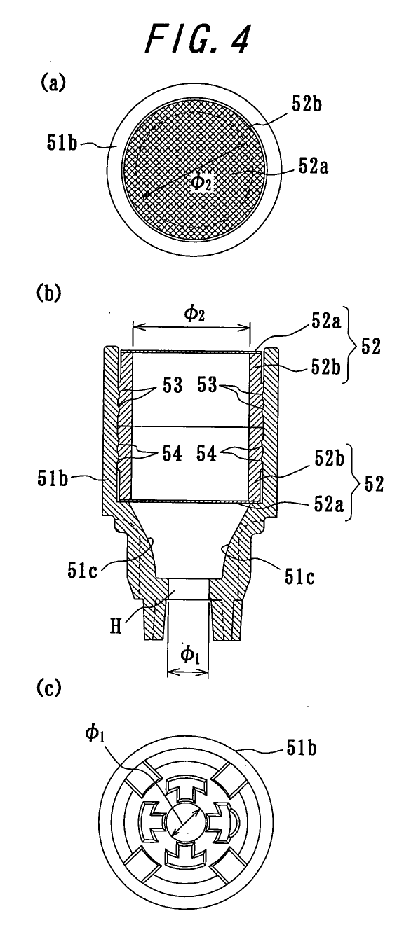

FIGS. 4(a) through 4(c) show another embodiment of the foaming element 50 in the foamer dispenser according to the present invention. Like reference numerals as used in FIGS. 1 through 3 will be used to denote corresponding components in the following description, and their otherwise redundant description will be omitted.

The foaming element 50 according to this embodiment has an internal passage penetrating through the jet ring 51 and having a circular cross-sectional shape, and the inlet opening H of the jet ring 51 also has a circular cross-sectional shape having an opening diameter φ1 as shown in FIG. 4(c). Further, the tubular body 52b of the mesh ring 52 is annular in cross-sectional shape, and also the mesh 52a is circular in cross-sectional shape having an opening diameter φ2 as shown in FIG. 4(a).

In such a configuration, the ratio between the opening diameter φ1 of the inlet opening H to the opening diameter φ2 of the mesh 52a is set to meet the following relationship:
φ1:φ2=1:2.0 to 3.5
and more preferably, the following relationship:
φ1:φ2=1:2.2 to 3.2
As a concrete example, the inlet opening H of the jet ring 51 has the opening diameter φ1 of 1.0 mm, thus the opening area S1 is 0.78 mm², and each mesh 52a has the opening diameter φ2 of 2.3 mm, thus the contact area S2 is 4.15 mm².

Also in such a configuration, it is possible to provide an ejected foam having a fine and homogeneous foam quality irrespectively of the contents, thereby allowing exhibition of excellent appearance and comfortable hand feeling of the foam when presented on a hand of user. Particularly in this case, the ejected foam has a finer and more homogeneous foam quality, as compared with a case where the inlet opening H and meshes 52a of the jet ring 51 are polygonal in shape. Such an effect is considered to be provided by virtue of the inlet opening H and meshes 52a of the jet ring 51 which are all circular in transverse cross-sectional shape, thereby reducing an affection of turbulent flow caused within the jet ring 51.

Incidentally, formed inside the jet ring 51 of this embodiment are two ribs 53 for fixing one mesh ring 52 at the side of the depression head 40, and two ribs 54 for fixing the other mesh ring 52 at the side of the inlet opening H. This causes the mesh rings 52 to be each fixed inside the jet ring 51 by press fitting. Such a configuration allows the ribs 53, 54 provided on and inside the jet ring 51 to position the mesh rings 52 at arbitrary locations within the jet ring 51, respectively.

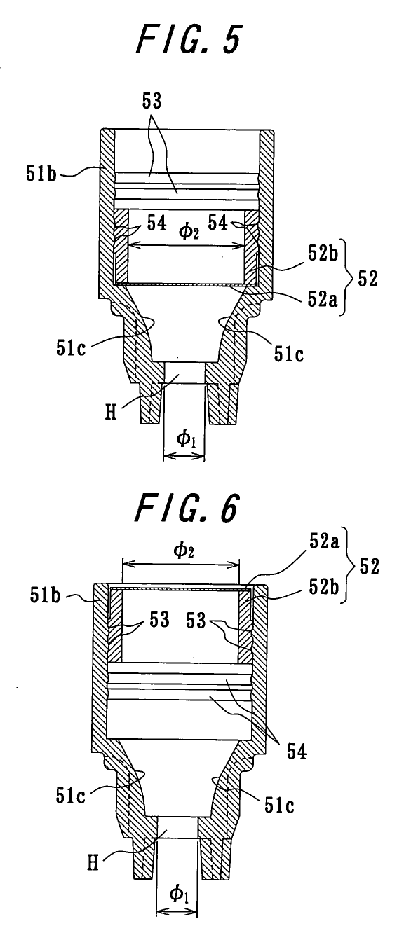

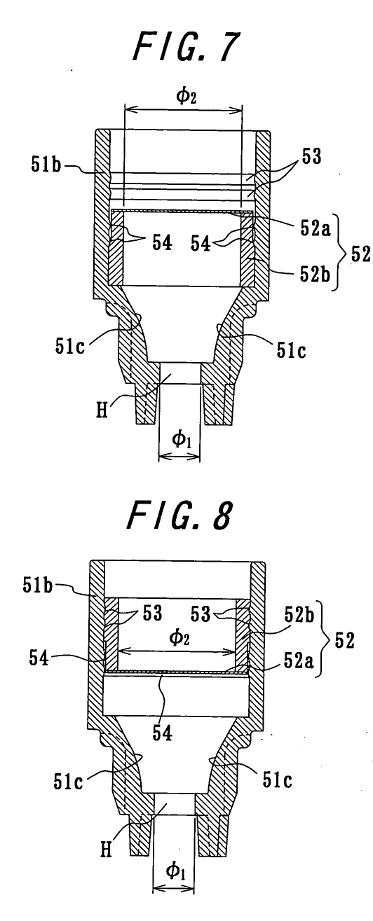

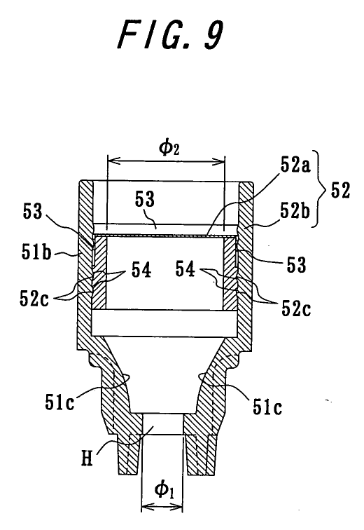

It is noted that FIG. 5 shows a state of the foaming element 50 shown in FIG. 4, having only the mesh ring 52 fixed at the inlet opening H side, while excluding the mesh ring 52 at the depression head 40 side. FIG. 6 shows a state of the foaming element 50 shown in FIG. 4, having only the mesh ring 52 fixed at the depression head 40 side, while excluding the mesh ring 52 at the inlet opening H side. FIG. 7 shows a state of the foaming element 50 shown in FIG. 5 where the mesh 52a is arranged to face toward the depression head 40. Further, FIGS. 8, 9 illustrate combining manners for fitting the applicable mesh ring 52 onto the ribs 53 or ribs 54 of the jet ring 51 in the foaming element 50 shown in FIG. 4, respectively.

Namely, by the configuration of this embodiment to provide the ribs 53, 54 inside the jet ring 51 and to position the relevant mesh ring 52 by these ribs 53, 54, it is possible to readily change the distance L from the inlet opening H to the relevant mesh ring 52 as shown in FIGS. 5 through 9, correspondingly to a desired foam quality to be previously contemplated depending upon the physical properties, usage, etc. of the contents. In this case, the physical properties of the contents, the desired foam quality, etc. can be dealt with by only positioning the mesh ring(s) 52 relative to the jet ring 51, thereby avoiding increase in number of parts and assembling steps, etc., accompanying to change in the physical properties of the contents, foam qualities, etc.

It is further noted that the tubular body 52b of the mesh ring 52 in this embodiment may be provided, at its side surface, with grooves 52c (not shown) to be detachably fitted onto the ribs 53, 54. It is also possible that the ribs 53, 54 are provided at an outside surface of the mesh ring 52, instead of inside the jet ring 51.

The present invention is not limited to the above-described preferred embodiments, and can be of course realized in various modified forms.

1. A foamer dispenser comprising: a base cap fixedly held at a container mouth; two pumps attached to the base cap and configured to separately suck, pressurize, and pressure-feed ambient air and the liquid contents filled in the container; a depression head for defining a merging space for merging outlet passages of the pumps with each other, the depression head having an ejecting end communicated with the outside, and the depression head having an internal passage for communicating the merging space with the ejecting end, so as to eject contents mixed with the ambient air from the ejecting end by repeating depressing and returning operations of the depression head; and a foaming element disposed within the internal passage of the depression head and configured to foam the contents mixed with the ambient air;
wherein said foaming element comprises: a jet ring having an inlet opening with an opening area narrower than that of said internal passage of said depression head, the jet ring comprising a tubular body with an opening area larger than that of the inlet opening and communicated with said internal passage of said depression head; and a mesh disposed within said tubular body of said jet ring so as to face to said inlet opening of said jet ring, said mesh having a number of fine holes to be contacted with the contents mixed with the ambient air and supplied from said inlet opening to allow a part of the contents to pass through said mesh; and
wherein said mesh has an opening diameter φ2 which is 2.0 to 3.5 times as large as an opening diameter φ1 at the inlet opening of said jet ring.

2. The foamer dispenser according to claim 1, wherein said mesh has the opening diameter φ2 which is 2.2 to 3.2 times as large as the opening diameter φ1 at said inlet opening of said jet ring.

3. The foamer dispenser according to claim 1, wherein said jet ring has a tapered surface or curved surface connecting between said inlet opening and said mesh.

4. The foamer dispenser according to claim 1, wherein said pumps consist of a dual pump comprising: a cylinder suspended from a lower surface of said base cap, and configured to cooperate with an inner periphery of the mouth of the container to define an annular gap therebetween which is communicated with an interior of the mouth and sealed by said base cap; and two pistons arranged in series with each other within said cylinder so as to be slidable therein; and
wherein said pistons are configured to separately suck, pressurize, and pressure-feed the contents within the container and the ambient air.

5. The foamer dispenser according to claim 4, wherein said dual pump is formed with an ambient air introduction port at a cylinder portion constituting the pump for sucking, pressurizing, and pressure-feeding the ambient air, the ambient air introduction port being blocked by said piston for sucking, pressurizing, and pressure-feeding the ambient air when said piston is in a stationary state where said piston is kept unslid, and the ambient air introduction port being released from said piston when said piston is depressed, to thereby introduce ambient air into the container.
